(19) United States
(12) Patent Application Publication
(10) Pub. No.: US 2021/0174484 A1
(43) Pub. Date: Jun. 10, 2021

(54) SYSTEM FOR MEASURING CRIMPED CONTAINER SEAMS

(71) Applicant: ONEVISION CORPORATION, Westerville, OH (US)

(72) Inventors: Neil Morris, Westerville, OH (US); Ben Allen, Westerville, OH (US)

(21) Appl. No.: 17/112,509

(22) Filed: Dec. 4, 2020

Related U.S. Application Data
(60) Provisional application No. 62/943,567, filed on Dec. 4, 2019.

(51) Int. Cl. G06T 7/00; G06T 7/62; H04N 7/18; H04N 5/225

(52) U.S. Cl. CPC G06T 7/001; G06T 7/62; G06T 2207/30128; H04N 5/2256; G06T 2207/10016; H04N 7/18

(57) ABSTRACT

A system and method for inspecting a can seam includes capturing or receiving images of a can. The images including at least an image of a can body or wall and a can seam. Dimensions or parameters of the can are calculated based on the images of the can body or the can seam. The dimensions or parameters are compared to a predetermined range, value, or profile associated with or corresponding to a compliant can (e.g., a non-defective can) to identify any deviations from the predetermined value. Upon identifying a deviation based on the comparison, the deviation may be associated with a particular defect, and an indication of the identified defect is provided (e.g., via a display or user interface (e.g., a graphic user interface)).

### CROSS-REFERENCE TO RELATED APPLICATION

This application claims priority to and all benefit of U.S. Provisional Patent Application Ser. No. 62/943,567, filed on Dec. 4, 2019, the entire disclosure of which is incorporated herein by reference.

### TECHNICAL FIELD

The general inventive concepts relate generally to systems and method for scanning seams used in food and beverage containers.

### BACKGROUND

Double seams are used by can fillers and can makers to ensure a high-quality seal inside a metal container for food and beverage products. A proper seal helps provide long durability of contents and separates the contents from environmental hazards and contamination. The double seam operation is typically performed using a can seamer. After a can is filled, a lid can be placed atop the other end of the can body. A can seamer is used to form a double seam between the can body and the lid. The double seam operation is performed inside a seamer machine. The cover or lid is seated into a chuck, the filled can body rests on an associated base plate, and the lid carried by the chuck, and the cover is installed into the open end on the filled can body. The cover and can flange are then folded twice into a completed double seam. For sealing integrity, the double seam closure must be maintained all the way around the perimeter of the can. This closure operation is a critical for can fillers and can makers, requiring routine checks to maintain quality.

The Food and Drug Administration (FDA) requires that double seams be measured every 4 hours on a complete set of cans from a seaming line, with at least one sample from each seamer head. Seamers contain multiple heads. These tests are destructive in nature requiring a seam to be torn apart or cut and inspected by measuring the components of the cross-sections of the double seam. For example, a seam saw is used to cut 1 to 4 sections at regular intervals, and images of the cut seams are inspected and recorded. The typical food canning process produces 400 to 1200 cans per minute. Consequently, seam inspections at 2 to 4-hour intervals are evaluating a very small percentage of production.

In addition to detailed internal seam inspections, visual checks of the external seam are a great aid to maintaining seam quality. Visual checks of the external double seam from each seamer head are typically completed every 30 minutes, and this process traditional detects 80% to 90% of double seam quality issues. This manual process of evaluating seam quality parameters is tedious and imprecise. For example, technicians can suffer fatigue and reduced efficiency over time in evaluating seam parameters. A better system and method for maintaining seam quality and detecting seam irregularities without the need for destructive testing of the subject seam is needed to ensure maintenance and reliability of this critical aspect of the food supply.

### SUMMARY

In an exemplary embodiment, a system for inspecting a can is provided. The system includes a computer readable memory including instruction stored thereon. The system also includes a processor in communication with the computer readable memory. The processor is operably configured to execute the instructions to perform one or more operations. The operations includes capturing an image of a can. The captured image of the can includes at least a portion of a can body and a can seam (e.g., a double seam). The operation also includes determining if the can is defective based on a comparison of the images of the can body or the can seam to a profile corresponding to compliant can. Additionally, the operation includes identifying a defect in the can body or the can seam, and providing an indication of the identified defect.

In another exemplary embodiment, a can seam inspection system is provided. The inspection system includes a light source configured to illuminate portions of a can. The inspection system also includes an image capturing system operably configured to capture one or more images or video of portions of the can. Additionally, the inspection system includes a computer readable memory including instruction stored thereon. The inspection system further includes a processor in communication with the computer readable memory. The processor is configured to execute the instructions to perform one or more inspection operations. The one or more inspection operations include illuminating portions of the can via the light source. The inspection operation also includes capturing images of the illuminated can via the image capturing system. The captured images include at least a portion of a can body and a can seam. Additionally, the inspection operation includes calculating dimensions or parameters of the can using the captured images of the can body or the can seam. The inspection operation also includes determining if the dimensions or parameters deviate from a predetermined range or value representative of a compliant can. The operation further includes identifying a defect based on the deviation, and providing an indication of the identified defect.

In yet a further exemplary embodiment, a method for inspecting a can seam is provided. The method includes capturing and/or receiving images of an illuminated can. The captured images include at least a portion of a can body and a can seam. The method also includes calculating dimensions or parameters of the illuminated can using the captured images of the can body or the can seam. The method further includes determining if the calculated dimensions or parameters deviate from a predetermine range or value representative of a compliant can. Additionally, the method includes identifying a defect based on the calculated dimensions or parameters deviating from the predetermine range or value, and providing an indication of the identified defect.

These and other objects, features and advantages of the present disclosure will become apparent from the following detailed description of illustrative embodiments thereof, which is to be read in connection with the accompanying drawings.

### BRIEF DESCRIPTION OF THE DRAWINGS

These and other features of the general inventive concept will become better understood by means of the following description and accompanying drawings in which:

FIG. 1 illustrates a perspective view of an exemplary embodiment of a system for inspecting a can seam, in accordance with the general inventive concepts;

FIG. 2 is a process flow chart of a second exemplary embodiment of a can seam inspection system, in accordance with the general inventive concepts;

FIG. 3A illustrates a perspective view of first can seam defect identifiable via at least one of the exemplary embodiments of a system for inspecting can seams, in accordance with the general inventive concepts;

FIG. 3B illustrates a perspective view of second can seam defect identifiable via at least one of the exemplary embodiments of a system for inspecting can seams, in accordance with the general inventive concepts;

FIG. 3C illustrates a perspective view of third can seam defect identifiable via at least one of the exemplary embodiments of a system for inspecting can seams, in accordance with the general inventive concepts;

FIG. 3D illustrates a perspective view of fourth can seam defect identifiable via at least one of the exemplary embodiments of a system for inspecting can seams, in accordance with the general inventive concepts;

FIG. 3E illustrates a perspective view of fifth can seam defect identifiable via at least one of the exemplary embodiments of a system for inspecting can seams, in accordance with the general inventive concepts;

FIG. 4 is a flowchart of an exemplary embodiment of a method for inspecting a can seam, in accordance with the general inventive concepts; and

FIG. 5 is a flowchart of a second exemplary embodiment of a method for inspecting a can seam, in accordance with the general inventive concepts.

### DETAILED DESCRIPTION

The general inventive concepts will be understood more fully from the detailed description given below and from the accompanying drawings of the various aspects and implementations of the disclosure. This should not be taken to limit the general inventive concepts to the specific aspects or implementations, which are being provided for explanation and understanding only.

The general inventive concepts will be understood more fully from the detailed description given below and from the accompanying drawings of the various aspects and implementations of the disclosure. This should not be taken to limit the general inventive concepts to the specific aspects or implementations, which are being provided for explanation and understanding only.

Cylindrical metal cans with crimped seams around the top and/or bottom date to the turn of the 20th Century. Throughout this extended time period of use, a variety of metals such as tin-plated steel or tin-plated iron, steel, and aluminum, have been used to form the structure of a can. More recently cans formed of composite materials, or using both metal and composite materials have come into use. For the purposes of this disclosure, cans that are hermetically sealed are directed for primary attention, although other cans or containers are adaptable for use with the general inventive concepts described herein. The disclosed system provides an apparatus and method for readily assaying the quality of can assembly by measuring, recording, and tracking key parameters of samples from the assembly process.

Thus, use of the general inventive concepts described herein allows for real-time detection and prediction of seam quality (e.g., double seam quality), and the system enables correction of faults in can assembly before such faults become a significant issue.

In some embodiments, for example, where the can 10 is a three-piece can, manufacturing a can proceeds from forming a tube by rolling the side sheet, and then sealing the side seam, such as by well-known processes such as crimping, welding or soldering the lateral seam and joining the ends of the side sheet. Commonly the side sheet is a rectangle with the shorter side of the rectangle used to form the side seam. It should be obvious that the shape of the side sheet varies according to the requirements for certain products contained within the can. The side height to diameter ratio of the can cylinder can vary across a wide range, such as about 1:4 for a common “tuna can” to 2:1 for a common “soup can.” Side sheets may also be formed with one or more ribs to reinforce the can shape.

Following formation of the can body from the side sheet, the bottom of the can is installed to permanently seal the can bottom to the side sheets. The quality of the joining of the can bottom to the can body is commonly through use of a double crimped seam, and the integrity of the closure of that seam can be analyzed through implementation of the presently disclosed system. Once the can bottom is sealed, the can, now as an open-ended container may be packed for shipment to food processing facility for filling.

The open can is filled with product, and the lid installed. After installation of the lid, the lid is sealed to the sides of the can body. When a can is used to store food or other products subject to spoilage or microbial degradation, the finished can is sterilized, by high pressure steam for instance. Labels may be affixed to the can body at some chosen point in the process or printed directly on the side sheet.

The process of joining the wall of the side sheet forming the can body to the lid often is most through the process of forming a double crimped seam (also referred to as a double seam), from the material of the can body and the lid. Double seams are used by can fillers and manufacturers to ensure a high quality and hermetic seal inside a metal can container holding food and beverage products. The proper quality hermetic seal provides for long durability of the can contents and effectively separates the can contents from environmental hazards and microbial or environmental contamination.

Examination and assay of seam quality for a particular can lid seaming device (seamer head) and for a production line can be implemented by direct examination of a finished seam. In some embodiments, the finished seam may be examined to identify defects in the seam (i.e., the external double seam).

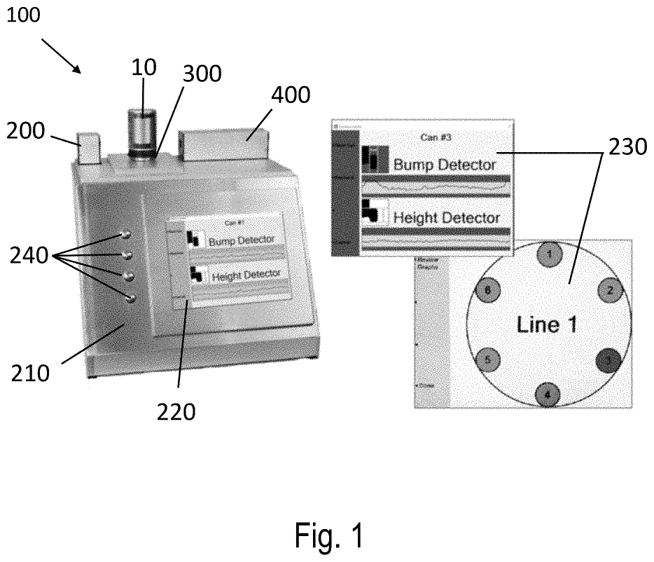

Referring now to the drawings, which are for purposes of illustrating exemplary embodiments of the subject matter herein only and not for limiting the same, FIG. 1 shows an exemplary embodiment of a system 100 for detecting defects in a can 10.

It should be appreciated that the system 100 provides an innovative approach to perform automatic visual measurements on the external can seam at the production line or remote from the production line.

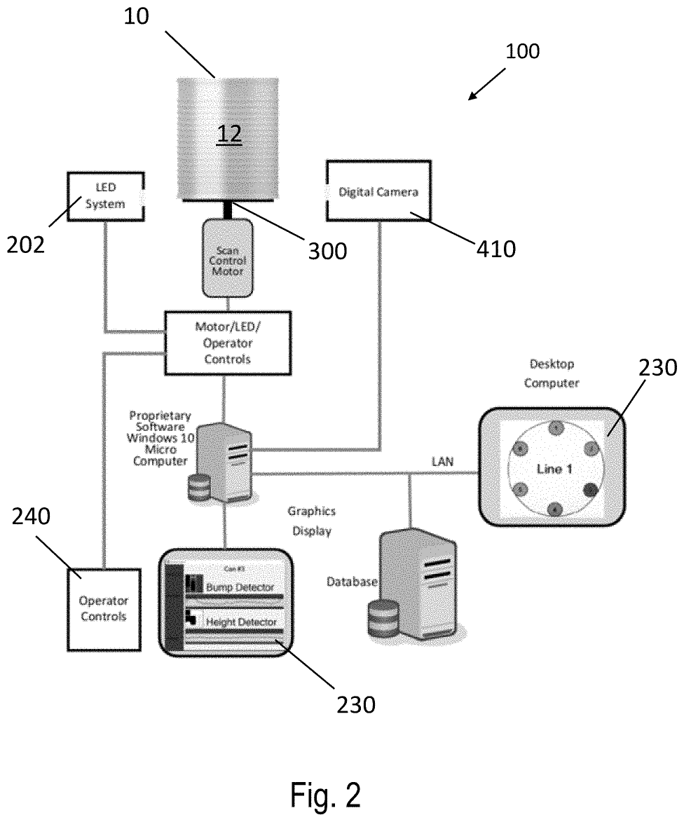

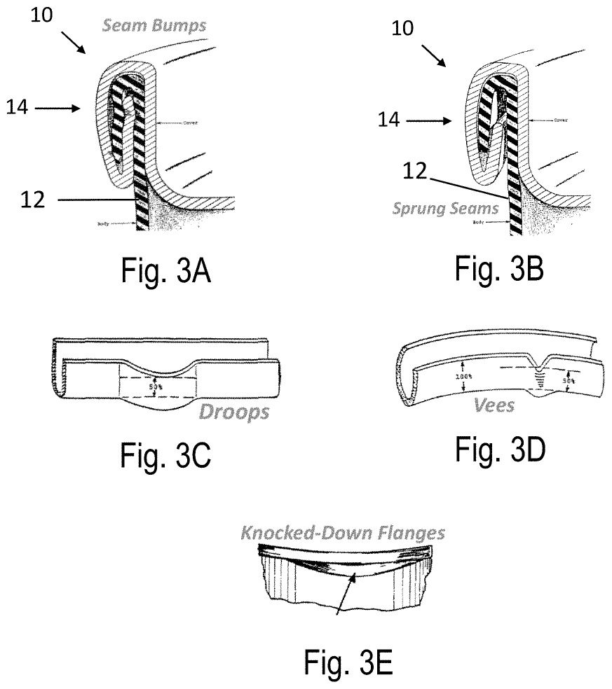

As shown in FIG. 2 and FIG. 3, the can includes at least a can body 12 (also referred to as a can wall) and a can seam 14. One or more of the defects that may be detected via the system 100 may include, for example, a sprung seam bump defect (FIG. 3A), a sprung defect (FIG. 3B), a seam droop defect (FIG. 3C), a seam vee defect (FIG. 3D) and/or a knocked-down flange defect (FIG. 3E). Additionally, or alternatively, the system 100 may detect small seam defects that may not be detectable via trained visual inspectors.

A sprung seam is a condition in which the seam is pulled away from the body wall. A seam bump is formed in the seaming process when there is inadequate space for the compound to fill tunnels in the internal double seam. A vee is an irregularity on the cover hook where the cover material does not form smoothly. These defects are important to avoid in the canning process because they affect product quality and safety in the food and beverage industries.

It should be further appreciated that performing a real-time visual inspecting of the can 10 at the production line allows reduces product hold times, as the system 100 provides a quick and more efficient method for identifying defects during the production process.

In some embodiment, the system 100 may include a memory operably connected to a processor. The memory (or other storage medium) may include programmable instructions for inspecting the can 10 for defects stored thereon.

The system 100 may further include a processor or similar processing circuitry operably connected to the memory. The processor may be configured to execute the programmable instructions to cause the system 100 (e.g., the processor or one or more component of the system 100) to perform one or more operations for inspecting the can 10 defects in the can 10, or more specifically, in the can seam 14 (e.g., the double seam as shown in FIG. 3A-FIG. 3B, or can wall (i.e., the can body 12).

In some embodiments, the system 100 may include or be operably connected to a lighting system 200 for illuminating the can 10 (or portions thereof) during an inspection operation. The lighting system 200 may include one or more light emitting diodes (LEDs 202 shown in FIG. 2) arranged to illuminate the can 10 or portions thereof during the inspection operation and, for example, while the can 10 is rotated (i.e., turns) on a moveable platform or spindle 300.

In some embodiments, the system 100 may include or be operably connected to the spindle 300. The spindle 300 may be sized or other shaped for arranging the can 10 thereon, and for restricting or otherwise limiting a movement of the can 10 during the inspection process (e.g., an image capturing process). In some embodiments, rotation of the spindle 300 may be achieved by a motor or similar rotating system known in the art and capable of rotating or moving the can 10 during the inspection process.

In some embodiments, rotation of the spindle 300 may be controlled by one or more of the processor, or other controller or processing circuitry of the system 100.

In some embodiments, the system 100 may include or be operably connected to an imaging system 400 for creating one or more images (e.g., a digital image) of the can 10 or portions thereof (e.g., the can wall or can seam 14) during the inspection process via the system 100, or in some embodiments, prior to initializing the system 100.

The imaging system 400 may include an image capturing device (e.g., a camera 410). Additionally, or alternatively, the imaging system 400 may include an image processing device (e.g., a processor of the imaging system 400.

It should be appreciated that, in some embodiments, the processor of the system 100 may be configured to process any captured or received images, calculate any dimensions and/or parameters of the digital can image, determine if the can 10 has any defect, and alert a user about the defect or provide an indication of the defect.

Additionally, or alternatively, the system 100 processor may be configured to control operations (or perform functions) of one or more of the subsystems of the system 100, e.g., the lighting system 200 and imaging system 400.

In some embodiments, an enclosure 210 may be provided to enclose one or more components and/or subsystems of the system 100. For example, the system 100 memory and processor may be enclosed within the enclosure 210. Additionally, or alternatively, one or more subsystems may be arranged atop the enclosure 210 (FIG. 1) for inspecting the can 10 for defects. For example, as shown in FIG. 1, the lighting system 200, spindle 300, and imaging system 400 may be disposed on a top side of the enclosure 210, with the lighting system 200 and the imaging system 400 arranged on opposite sides of the spindle 300. In some embodiments, the enclosure 210 may also enclose one or more networking components configured to transmit inspection information (data) to and from systems within the system 100 and/or systems remote from the system 100 (e.g., a remote user workstation for inspecting results or indications from the system 100.

In some embodiments, the system 100 may include a display 220 that may be attached or otherwise integrated in the enclosure 210 (as shown in FIG. 1). Additionally, or alternatively, the system 100 may be operably connected to the display 220, for example, via a WAN, LAN, or similar wired or wireless network, where the display 220 is remote from the product line (e.g., at the user workstation). In the embodiment of FIG. 1, the display 220 is arranged and/or attached to a front side of the enclosure 210.

In some embodiments, execution of the programmable instructions may create or otherwise display a user interface (UI 230) (e.g., a graphic user interface) for the system 100. The UI 230 may display information corresponding to the inspection process or the results of the inspection to, for example, a user. In some embodiments, when the user receives the results of the inspection, one or more options, for example, provided via the UI 230 may provide the user with an option to save the data or to again inspect one or more of the cans 10 that were previously inspected to confirm any results.

In some embodiments, the UI 230 provides information corresponding to the dimensions and/or parameters for the can 10 or digital image of the can 10. For example, a thickness and/or height of the can seam 14 may be displayed via the UI 230.

In some embodiments, a can seam 14 thickness may be the distance from an outside surface of the can seam 14 to the can wall outer surface. Additionally, or alternatively, a can seam height may be the distance from

Additionally, or alternatively, the UI 230 may provide (or otherwise display (e.g., via the display 220)) graphs, charts, or similar diagrams showing relationships between any captured or received images and one or more predetermined ranges, values, or profiles corresponding to a can 10 that is compliant (e.g., without any defects).

In some embodiments, the UI 230 may provide inspection information to the user via a number of different pages and/or views, with each page or view providing an indication of an identified (detected) defect to a user so that the user may take corrective actions eliminate further can defects. In some embodiments, upon identifying the defect, the user may adjust one or more settings for the seaming process (e.g., at the can seamer) that may be the cause of the defect identified via inspection process; save the data for accessing at a later time; and/or retest any of the cans 10 to confirm the prior results.

In some embodiments, one or more controls 240 (e.g., knobs or buttons) may be provided with the enclosure 210 to allow the user to select one or more options displayed on the UI 230. The one or more options may correspond to one or more steps in the inspection process and/or reinspection process. In some embodiments, for example, as shown in FIG. 1, the system 100 may include controls 240 for toggling between pages of the UI 230. In the exemplary embodiment of FIG. 1, a first page of the UI 230 is shown displaying can 10 and/or information corresponding to the can 10 measurements, along with defect information, which may be identified using a bump detector. The bump detector may be a component of the system 100, or in some embodiments, programmable instructions for measuring a seam bump, and/or calculating measurements corresponding to a seam bump, for example, based on the captured image, is displayed via the display 220.

Additionally, as shown in FIG. 1, the first page, and in some embodiments, any subsequent pages (or similar interfaces) of the UI 230, may display defect information identified using a height detector. The height detector may be a component of the system 100, or in some embodiments, programmable instructions for measuring a seam height, and/or calculating measurements corresponding to a seam height, for example, based on the captured (or received) image.

In some embodiments, the UI 230 may be configured to change or adjust its color scheme based on a defect being identified and/or a defect type. In some embodiments, the color scheme (or other indicia) may be changed on the initial page generated or otherwise displayed by the UI 230, or in other embodiments, multiple pages may be changed (e.g., have different color schemes) to reflect and/or correspond to the inspected can's 10 condition. For example, the UI 230 may provide a red color scheme to alert the user about a defect in the can 10 being inspected or that has been inspected and is a part of a series previously inspected, or a green color scheme indicative of any cans 10 that pass inspection.

In some embodiments, the display 220 may be a touch display (e.g., a multi-touchscreen display). In this embodiments, the executable instructions that may be associated with one or more of the controls 240 may be associated with selectable options provided via the touch display 220. Selecting (e.g., touching the screen) at or near the selectable option may cause the processor or system within the system 100 to execute one or more of the programmable instructions for inspecting the can 10.

With continued reference to the figures, the system 100 (and more specifically the spindle 300) may be configured to accommodate cans 10 having diameters ranging from 202 to 603. In some embodiments, a set of cans 10 from a can seamer may be inspected every 30 minutes. The system 100 provides a means to sample the process cans 10 more frequently and, more accurately, and provides real time information to supervision and the maintenance staff, helping predict and prevent defective double seam production. It should be appreciated that frequent, more accurate sampling enables quicker correction of the seaming process.

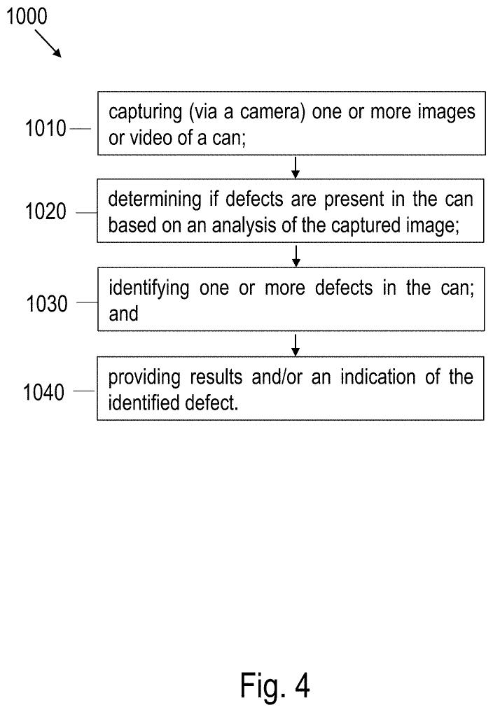

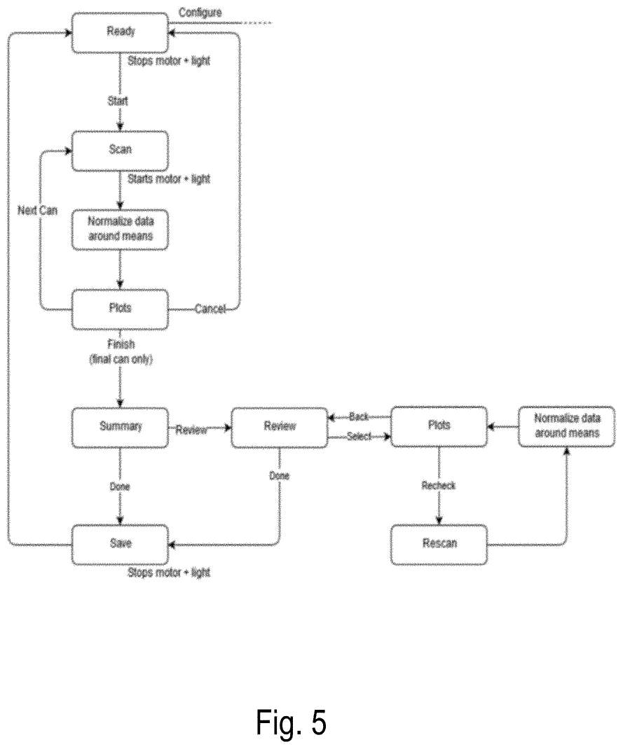

With continued reference to the figures, and now with reference to FIG. 4 and FIG. 5, an exemplary method 1000 for inspecting a can 10 (or more specifically a can seam 14 or can wall) is provided. It should be appreciated that the method 1000 may be performed in a different order, with illustrated steps omitted, with additional steps added, or with a combination of reordered, combined, omitted, or additional steps.

It should also be appreciated that, in an exemplary embodiment where the system 100 is positioned in the vicinity of the production line. An operator (user) may select can 10 samples according to a predetermined sampling scheme.

In step 1010, capturing (via the camera 410) an image of the can 10. In some embodiments, the camera 410 may capture an image of the can 10. The image may include at least portions of the can body 12 (e.g., the can wall) and can seam 14. The camera 410 may be configured to convert the captured image into a digital image or image file for processing via the camera 410 and/or the system 100 processor.

In some embodiments, a previously captured image of the can 10 may be provided to the system 100 (or imaging system 400) for analysis of the captured image by the system 100 (or more specifically, via the programmable instructions executed via the processor).

It should be appreciated that prior to capturing the image, the method 1000 may include steps for selecting a can 10, and arranging (or otherwise placing) the can 10 at or near the rotating spindle 300 and in a field of view of the camera 410. The lighting system 200 (or similar light source) may then illuminate an outside profile of the can 10 (e.g., at the can seam 14), while the camera 410 (e.g., a precision high-resolution digital camera) captures a series of 600 to 1200 profile images of the can 10 (e.g., at the external double seam). It should be appreciated that the camera 410 may capture multiple images in order to provide enough data points to establish a means for any undesirable deviations (defects) in the can 10 anatomy. It should be further appreciated, that the mean may be used when determining if a defect is present in the can 10, and in some embodiments, the how much or significant the defect in the can 10 may be. This information may be provided to the user, via the system 100, in real-time for adjusting one or more settings of the can crimping and/or seaming process to prevent further defective cans 10 from being produced.

In some embodiments, for example, upon capturing the images, the captured images may be stored in the memory and/or other storage medium for being subsequently accessed by (or delivered to) the processor or other subsystem of the system 100. It should be appreciated that, in some embodiments, the stored captured images may be remotely accessible by inspectors or other users that may be remote from the production line.

In some embodiments, while the can 10 is rotating in the field of view at or near the spindle 400, at least two measurements (e.g., dimensions or parameters) are generated (determined) on each profile sample (i.e., each can 10 profile). In some embodiments, one measurement may be of a seam bump in a radial direction. Additionally, or alternatively, another measurement may be a seam height in a vertical direction. In some embodiments, one or more of the measurements may be calculated or otherwise determined by the system 100 processor upon analyzing the captured images. Additionally, or alternatively, one or more subsystems (e.g., the imaging system 400) may generate the measurements and transmit or make available the generated measurements to the processor for further analysis.

In some embodiments, one or more ranges, limits, value, or similar profiles may be provided or preprogrammed/predetermined, for example, by an inspector to enable the system to automatically detect variations outside of such limits. It should be appreciated that these limits may be indicative of or correspond to a compliant can 10 (e.g., a can without defects that could compromise the can 10 contents).

In step 1020, determining if defects are present in the can 10 based on an analysis of the captured image. In some embodiments, to determine if there are defects present in the can 10 (or can seam 14), the systems 100 may include programmable instructions for calculating one or more measurements (e.g., dimensions and/or parameters) corresponding to the inspected can 10 using the captured images including, in some embodiments, the images of the can body 12 and/or the can seam 14. The system 100 may then compare the calculated (or otherwise generated) measurements corresponding to the inspected can 10 to one or more predetermined values indicative of a compliant can. It should be appreciated that the system 100 may automatically detect/identify variations in the can seam 14 and determines an acceptance or rejection of each inspected can seam sample.

In step 1030, identifying one or more defects in the can 10. For identifying the defect type, the system 100 may include one or more preprogrammed and/or predetermined ranges, limits, value, or similar profiles, to enable the system to automatically detect variations outside of such limits. It should be appreciated that these limits may be indicative of or correspond to a compliant can 10 (e.g., a can without defects that could compromise the can 10 contents). In some embodiments, the system 100 may identify sprung seams with range limits at 4-6% of nominal and seam heights with range limits at 4-6% of nominal.

In some embodiments, for example, as the can 10 is rotated on a spindle 300 in the field of view of the camera 410, a rotation speed may be maintained within 2-3%, and 600 to 1200 measurements may be generated or otherwise calculated, for example, on the double seam profile in one rotation of the can 10. In some embodiments, a complete set of sample images may be recorded on the entire can 10 perimeter in a period of 5 seconds.

In some embodiments, the can 10 may be rotated multiple times until a desired about of images and/or measurements may be captured or calculated for the can 10 be inspected. For example, in some embodiments, the can 10 may be rotated at least three (3) times during the image capturing process to achieve the desired quantitative and qualitative results for determining if the can 10 includes any defects.

In step 1040, providing results and/or an indication of the identified defect. In some embodiments, the results and/or indications may be provided to the inspector, for example, via the display 220 (or in other embodiments, a remote user workstation).

Additionally, or alternatively, the inspection results (or similar data) may be presented in a graph format with radial and vertical measurements showing the deviation from nominal values (e.g., as shown by the UI 230 in FIG. 1). In the event a deviation limit is exceeded, the system 100 (or UI 230) may display the potential problem (defect) to the inspector in real-time. In some embodiments, the inspector can decide to re-check the can 10 or move on to the next can 10, as discussed below. It should be appreciated that, when the cans 10 from each seamer head has been inspected, the inspector may be prompted to complete the inspection. At that time, the collected data and graphs may be accessible and displayed by can 10 head on the line (i.e., via the UI 230 displaying information indicative of the inspected cans 10 (e.g., each can's 10 head) in a scheme or series.

With continued reference to FIG. 5, and upon receiving or otherwise accessing the results of the inspection, the method 1000 may include (e.g., at the inspector's request) the step of reviewing the captured or analyzed can image corresponding to the identified defect. In this step, the inspector may decide to save the results or confirm the results. It should that depressing one or more of the controls 240 may cause the processor to execute instructions corresponding to the inspector's decision to save or confirm the results.

If the inspector decides to save the results, the processor may execute instructions to write or otherwise store the results in the memory or other storage device in operable communication with the system 100 or one or more components thereof.

If the inspector decides to confirm the results of the inspection, the inspector may select a control 240 corresponding to instructions for recapturing the defective can 10 image e.g., using the imaging system 400). Upon recapturing the image, the system 100 may perform steps to confirm the presence of the can 10 defect by calculating measurements of the recaptured image, and comparing the measurements of the recaptured image to one or more predetermined values to identify, and thus confirm, the defect.

It some embodiments, in lieu of recapturing the can 10 image, the user may elect to reprocess the previously captured image (i.e., the image previously processed via the system 100) to confirm the presence of the defect in the can 10. In this embodiments, the instructions, when executed by the processor, may cause the system 100 to recalculate the measurements (or use the previously calculations) for comparing to the predetermined values to identify, and thus confirm, the defect. Upon confirming the defect, an indication of the confirmed defect may be provided to the inspector (e.g., via the display 220) or via another means for confirming a defect (e.g., via audible confirmation), and at which time the inspector may elect to save the previous and/or confirmed results.

In some embodiments, the system 100 may be started manually by a user (e.g., a seam inspector), or in other embodiments, the system 100 may be started upon the system 100 detecting the can 10. The can 10 may be detected using one or more sensors (not shown) of the system. In some embodiments, the sensors may be included with one or more of the lighting system 200, the imaging system 400, and/or other sensing system at or near an area where the can may be arranged for inspection. In some embodiments, the sensing system may be at or near a rotatable spindle 300 or similar movable platform of the system 100.

In some embodiments, the system 100 may include a self-diagnostic feature. The self-diagnostic feature may be programmable instructions, executable by the processor, for identifying any anomalies in the system 100. If anomalies are present, the inspector may be alerted to the presence of the anomalies and the need to reboot or service the system 100.

In general, the computing systems and devices described herein may be assembled by a number of computing components and circuitry such as, for example, one or more processors (e.g., Intel®, AMD®, Samsung®) in communication with memory or other storage medium. The memory may be Random Access Memory (RAM), flashable or non-flashable Read Only Memory (ROM), hard disk drives, flash drives, or any other type of memory known to persons of ordinary skill in the art and having storing capabilities. The computing systems and devices may also utilize distributed cloud computing technologies to facilitate several functions, e.g., storage capabilities, executing program instruction, etc. The computing systems and devices may further include one or more communication components such as, for example, one or more network interface cards (NIC) or circuitry having analogous functionality, one or more one way or multi-directional ports (e.g., bi-directional auxiliary port, universal serial bus (USB) port, etc.), in addition to other hardware and software necessary to implement wired communication with other devices. The communication components may further include wireless transmitters, a receiver (or an integrated transceiver) that may be coupled to broadcasting hardware of the sorts to implement wireless communication within the system, for example, an infrared transceiver, Bluetooth transceiver, or any other wireless communication know to persons of ordinary skill in the art and useful for facilitating the transfer of information.

While specific embodiments have been described in detail, those with ordinary skill in the art will appreciate that various modifications and alternative to those details could be developed in light of the overall teachings of the disclosure. For example, elements described in association with different embodiments may be combined. Accordingly, the particular arrangements disclosed are meant to be illustrative only and should not be construed as limiting the scope of the claims or disclosure, which are to be given the full breadth of the appended claims, and any and all equivalents thereof. It should be noted that the terms “comprising”, “including”, and “having”, are open-ended and does not exclude other elements or steps; and the use of articles “a” or “an” do not exclude a plurality.

What is claimed is:

1. A system for inspecting a can comprising:
a computer readable memory including instruction stored thereon;
a processor in communication with the computer readable memory and configured to execute the instructions to perform at least the following operations:
capturing an image of a can, wherein the image includes at least a portion of a can body and a can seam;
determining if the can is defective based on a comparison of the images of the can body or the can seam to a profile corresponding to compliant can;
identifying one or more defects in the can body or the can seam based on the comparison; and
providing results indicative of the one or more identified defects.

2. The system of claim 1, wherein the can seam is a double seam.

3. The system of claim 1, wherein capturing the image of the can includes:
illuminating portions of the can via a lighting system and capturing the image via an image capturing system.

4. The system of claim 3, wherein the captured image is stored in the memory or other storage medium.

5. The system of claim 3, wherein the lighting system includes an LED, and wherein the image capturing system includes a camera.

6. The system of claim 3 further comprising:
a rotatable spindle, wherein the can is arranged on the rotatable spindle prior to capturing the image of the can, and wherein the can rotates on the spindle while the image of the can is being captured.

7. The system of claim 1, wherein the identified defect is one or more of a seam bump defect, a sprung seam defect, a knocked-down flange defect, a droop defect, or a vee defect.

8. A can seam inspection system comprising:
a light source configured to illuminate portions of a can;
an image capturing system configured to capture one or more images or video of portions of the can;
a computer readable memory including instruction stored thereon;
a processor in communication with the computer readable memory and configured to execute the instructions to perform at least the following operations:
illuminating portion of the can via the light source;
capturing images of the illuminated can via the image capturing system, wherein the captured images include at least a portion of a can body and a can seam;
calculating dimensions or parameters of the can using the captured images of the can body or the can seam;
determining if the dimensions or parameters deviate from a predetermined range or value representative of a compliant can;
identifying a defect based on the deviation; and
providing an indication of the identified defect.

9. The system of claim 8, wherein the can seam is a double seam.

10. The system of claim 8, wherein the indication of the identified defect is provided via a display of a user workstation in communication with the system.

11. The system of claim 10, wherein the user workstation communicates with the system over a WAN, LAN, or cellular network.

12. The system of claim 8, wherein calculating dimensions or parameters of the can includes identifying a bump and a height of the can seam.

13. The system of claim 12, wherein the identified defect is based on deviations corresponding to the can seam bump.

14. The system of claim 12, wherein the identified defect is based on deviations corresponding to the can seam height.

15. A method for inspecting a can seam comprising the steps of:
receiving images of an illuminated can, wherein the received images include at least a portion of a can body and a can seam;
calculating dimensions or parameters of the illuminated can using the received images of the can body or the can seam;
determining if the calculated dimensions or parameters deviate from a predetermined range or value representative of a compliant can;
identifying a defect based on the calculated dimensions or parameters deviating from the predetermined range or value; and
providing an indication of the identified defect.

16. The method of claim 15, wherein the can seam is a double seam.

17. The method of claim 15, calculating dimensions or parameters of the can includes identifying a bump and a height of the can seam.

18. The method of claim 17, wherein the identified defect is based on deviations corresponding to the can seam bump.

19. The method of claim 17, wherein the identified defect is based on deviations corresponding to the can seam height.

20. The method of claim 15 further comprising:
recalculating the dimensions or parameters of the illuminated can using the received images or newly captured images of the can body or the can seam to confirm that the can includes a the identified defect;
determining if the recalculated dimensions or parameters deviate from the predetermine range or value; and
upon identifying a deviation from the predetermined range or value, confirming the identified defect via the indication or using a second indication.
